(19) United States
(12) Patent Application Publication
(10) Pub. No.: US 2012/0267946 A1
(43) Pub. Date: Oct. 25, 2012

(54) ANNULAR SEAL MEMBER AND BRAKE FLUID PRESSURE CONTROL APPARATUS USING THE SAME

(75) Inventors: Masato OGAWA, Ichinomiya-shi (JP); Ayumi YAMAMURA, Chiryu-shi (JP); Masayuki HIJIKATA, Nagoya-shi (JP); Koji YANAI, Kariya-shi (JP)

(73) Assignees: DENSO CORPORATION, Kariya-shi (JP); ADVICS CO., LTD., Kariya-shi (JP)

(21) Appl. No.: 13/455,629

(22) Filed: Apr. 25, 2012

(30) Foreign Application Priority Data
Apr. 25, 2011 (JP) 2011-096877

(51) Int. Cl. B60T 13/68; F16J 15/02

(52) U.S. Cl. 303/20; 277/649

(57) ABSTRACT

An annular seal member includes: an annular base part; and a seal edge, which is provided on both end faces of the annular base part to protrude in opposite directions, wherein the seal edge is configured to closely contact with a opposing face of a seal target such that an inner periphery side of the base part and an outer periphery side of the base part are fluid-tightly partitioned, wherein a plurality of the seal edges is provided in parallel with each other in at least one area of the base part, and wherein the number of the seal edges in the at least one area of the base part is larger than the number of the seal edges in the other area of the base part.

### CROSS-REFERENCE TO RELATED APPLICATION

This application claims priority from Japanese Patent Application No. 2011-096877 filed on Apr. 25, 2011, the entire subject matter of which is incorporated herein by reference.

### TECHNICAL FIELD

This disclosure relates to an annular seal member, which is used as a seal between mating faces (facing faces) of two members, and a brake fluid pressure control apparatus, which improves reliability of a seal of mating faces of a valve block having a fluid pressure control valve installed thereto and a casing having an electronic control device accommodated therein by using the annular seal member while suppressing an increase in a size of the apparatus.

For example, JP-A-2008-275089 discloses an annular seal member that seals a gap between two members. Also, JP-A-2008-285167 discloses a fluid pressure control apparatus having integrated an electronic control device, in which an annular seal member is used to seal mating faces of a valve block having a fluid pressure control valve installed thereto and a casing having the electronic control apparatus accommodated therein.

The annular seal member of JP-A-2008-275089, which is also referred to as a seal ring, seals between a shaft hole and a shaft inserted into the shaft hole and has three seal edges on inner and outer peripheries, respectively. The three of seal edges on the inner and outer peripheries are compressed to an inner periphery of the shaft hole and an outer periphery of the shaft, respectively, so that the mounting stability of the annular seal member is enhanced and twist or torsion is suppressed to improve the sealing characteristics.

### SUMMARY

In cold regions, an anti-freezing agent is sprinkled in many cases so as to melt the snow or to suppress the freezing. The anti-freezing agent is calcium chloride or sodium chloride. A solution of the anti-freezing agent may be adhered to the brake fluid pressure control apparatus mounted on a vehicle and may corrode the valve block.

Meanwhile, the brake fluid pressure control apparatus includes a valve block having a body made of aluminum alloy and the like, a casing that is made of resin and fixed to the valve block, and a mounting substrate that mounts thereon parts of an electronic control device is accommodated in the casing. The brake fluid pressure control apparatus is configured to be mounted on the vehicle so that mating faces of the valve block and the casing is inclined with respect to a vertical face or a horizontal face.

In the mounted state, the adhered corrosion factors (salt or water) may remain or deposit on an upper face (a face facing the sky) of the brake fluid pressure control apparatus, an inclined surface of a corner part or a lower face (a face facing the ground) supported to a mount. Also, the casing is fastened to the valve block by bolts. A part having the bolt hole into which the fastening bolt is screwed and a provision area of a relief part that is provided on an outer periphery of the casing so as to suppress the torsion of the resin casing are deteriorated with regard to the draining characteristics, so that the corrosion factors are apt to remain and deposit thereon.

When the corrosion factors remain and deposit on the part corresponding to the seal part and the mating surface of the valve block is thus corroded, the corrosion factors are introduced from the corroded part into the casing through the seal part and thus damage the internal parts. The corrosion of the valve block does not proceed rapid process. However, for a brake fluid pressure control apparatus that is mounted on a truck having a long service life, it is preferable to take a countermeasure against the problem that the sealing characteristics are lowered due to the corrosion of the valve block.

In order to improve the sealing characteristics, it is effective to increase the number of the seal edges, as disclosed in JP-A-2008-275089. However, as the number of the seal edges increases, a seal width of the seal member is increased, so that a seal target product (fluid pressure control apparatus) becomes large-sized.

The brake fluid pressure control apparatus that is provided in an engine room and the like of the vehicle is constrained by a mounting space. Thus, the countermeasures that make the apparatus become larger are not to be adapted.

Meanwhile, the casing is integrally provided with a connector part for electrical connection. When a horizontal width of the casing is increased, a distance from a target part of the electrical connection to the connector part is changed, so that a mount substrate should be also replaced. Accordingly, due to such obstacles, it is unlikely considered that the countermeasures to improve the sealing characteristics between the valve block and the casing.

This disclosure provides at least an annular seal member to suppress the reliability of a brake fluid pressure control apparatus mountable on a truck having a long service life from being lowered, due to corrosion of a valve block, and this disclosure improve the reliability between mating faces of the valve block and a casing with suppressing an increasing in a size of the apparatus.

In view of the above, an annular seal member of this disclosure comprises: an annular base part; and a seal edge, which is provided on both end faces of the annular base part to protrude in opposite directions, wherein the seal edge is configured to closely contact with a opposing face of a seal target such that an inner periphery side of the base part and an outer periphery side of the base part are fluid-tightly partitioned. The annular seal member is configured that a plurality of the seal edges is provided in parallel with each other in at least one area of the base part, and the number of the seal edges in the at least one area of the base part is larger than the number of the seal edges in the other area of the base part.

In the above-described annular seal member, the number of the seal edges provided in parallel with each other in the at least one area of the base part may be three, and the number of the seal edges provided in parallel with each other in the other area of the base part may be two.

In a brake fluid pressure control apparatus of this disclosure, an area provided with the plurality of the seal edges is at lease one of an area along an upper face (a face facing the sky) of the control apparatus, an area along an lower face (a face facing the ground) of the control apparatus in case that the lower face of the control apparatus is supported by a mount, and an area along an lower part of the control apparatus in case that an attachment bracket is provided at a lower part of the control apparatus.

In order to satisfy the above configuration, this disclosure also provides the brake fluid pressure control apparatuses as follows. The brake fluid pressure control apparatus comprises a valve block, into which a fluid pressure control valve is installed; a casing, which accommodates an electronic control device; and the above-described annular seal member of this disclosure, wherein the casing is fitted and fastened to the valve block so as to surround the fluid pressure control valve, wherein the casing and the valve block are fluid-tightly sealed by the annular seal member, wherein the brake fluid pressure control apparatus is mountable on the vehicle so that mating faces of the valve block and the casing are inclined with respect to a vertical face or a horizontal face. In the above-described brake fluid pressure control apparatus, an area of the base part, which is arranged along an upper face of the control apparatus, is provide with the plurality of the seal edges, and the number of the seal edges in the area arranged along the upper face is larger than the number of the seal edges in the other area of the base part. Alternatively, in the above-described brake fluid pressure control apparatus, at least one of the casing and the valve block is formed with a bolt hole, into which a fastening bolt for fastening the casing and the valve block is screwed, and then an area of the base part, which is adjacent to the bolt hole, is provide with the plurality of the seal edges, and the number of the seal edges in the area adjacent to the bolt hole is larger than the number of the seal edges in the other area of the base part. Alternatively, in the above-described brake fluid pressure control apparatus, a lower face of the control apparatus is supported by a mount, and then an area of the base part, which is arranged along the lower face of the control apparatus, is provide with the plurality of the seal edges, and the number of the seal edges in the area arranged along the lower face is larger than the number of the seal edges in the other area of the base part. Alternatively, in the above-described brake fluid pressure control apparatus, an attachment bracket is provided at a lower part of the control apparatus, and then an area of the base part, which is arranged along the lower part of the control apparatus, is provide with the plurality of the seal edges, and wherein the number of the seal edges in the area arranged along the lower part is larger than the number of the seal edges in the other area of the base part.

In the above-described brake fluid pressure control apparatuses, the annular seal member may include an area, in which the seal edge is vertically arranged, and the number of the vertically arranged seal edges may be two.

According to the annular seal member of this disclosure, the seal edges are more provided in the part at which there is a high possibility of the corrosion. When the seal function of the outermost seal edge of the base part is damaged, the seal edge at the inner diameter side of the base part functions as a backup element. Thereby, it is possible to avoid that the part at which there is a high possibility of the corrosion becomes insufficiency at an early stage.

Also, the number of the seal edges is increased only in the partial area. Thereby, it is possible to avoid the unnecessary increase in the seal width of the other area, so that it is possible to suppress the increase in a size of a seal target product to be minimum.

Generally, the brake fluid pressure control apparatus for a vehicle is mounted on a vehicle, in which the mating faces of the valve block and the casing being is vertical and the connector part for electrical connection integrally formed to the casing is arranged at a side of the casing. In this arrangement, the size increase in the upper and lower directions (sky and ground directions) is not problematic. However, the size increase in a horizontal direction may not be permitted because there is a constraint with respect to a mounting space and it is necessary to replace a mounting substrate.

Even in the above state, when the annular seal member of this disclosure is used, it is possible to improve the reliability of the seal at a part, at which the corrosion factors are apt to remain and deposit, without increasing a size in the horizontal direction.

According to the brake fluid pressure control apparatus for a vehicle of this disclosure, the number of the seal edges of the annular seal member is increased at the part at which the corrosion factors are apt to remain and deposit and the unnecessary increase in the number of the seal edges in the other areas is suppressed. Accordingly, it is possible to improve the reliability of the seal of the mating faces of the valve block and the casing with suppressing the increase in a size of the apparatus.

The number of the seal edges is three in the area, in which the seal edges are more provided, and the number of the seal edges is two in the area, in which the seal edges are less provided, so that it is possible to further improve the corrosion resistance and to make the seal target product smaller at the same time. In the area in which the annular seal member is vertically arranged, the adhered corrosion factors are apt to run down. Therefore, in this area, the number of the seal edges is preferably two lines (which is the same as a product being currently sold), so that it is possible to avoid the size increase in the horizontal direction.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1A is a front view illustrating an example of an annular seal member of this disclosure, FIG. 1B is a sectional view taken along a line IA-IA of FIG. 1A and FIG. 1C is a sectional view taken along a line IC-IC of FIG. 1B;

FIG. 2A is a perspective view illustrating an outline of an example of a brake fluid pressure control apparatus of this disclosure, FIG. 2B is a sectional view taken along a line IIB-IIB of FIG. 2A, and FIG. 2C is a sectional view taken along a line IC-IC of FIG. 2A.

FIG. 3 is a sectional view illustrating a part of a mating surface seal part of the brake fluid pressure control apparatus of this disclosure of FIG. 2;

FIG. 4 is a sectional view illustrating a part of another exemplary mating surface seal part of a brake fluid pressure control apparatus of this disclosure;

FIG. 5 is a side view illustrating another example of a brake fluid pressure control apparatus of this disclosure; and

FIG. 6 is a sectional view illustrating a part of another exemplary mating surface seal part of a brake fluid pressure control apparatus of this disclosure.

### DETAILED DESCRIPTION

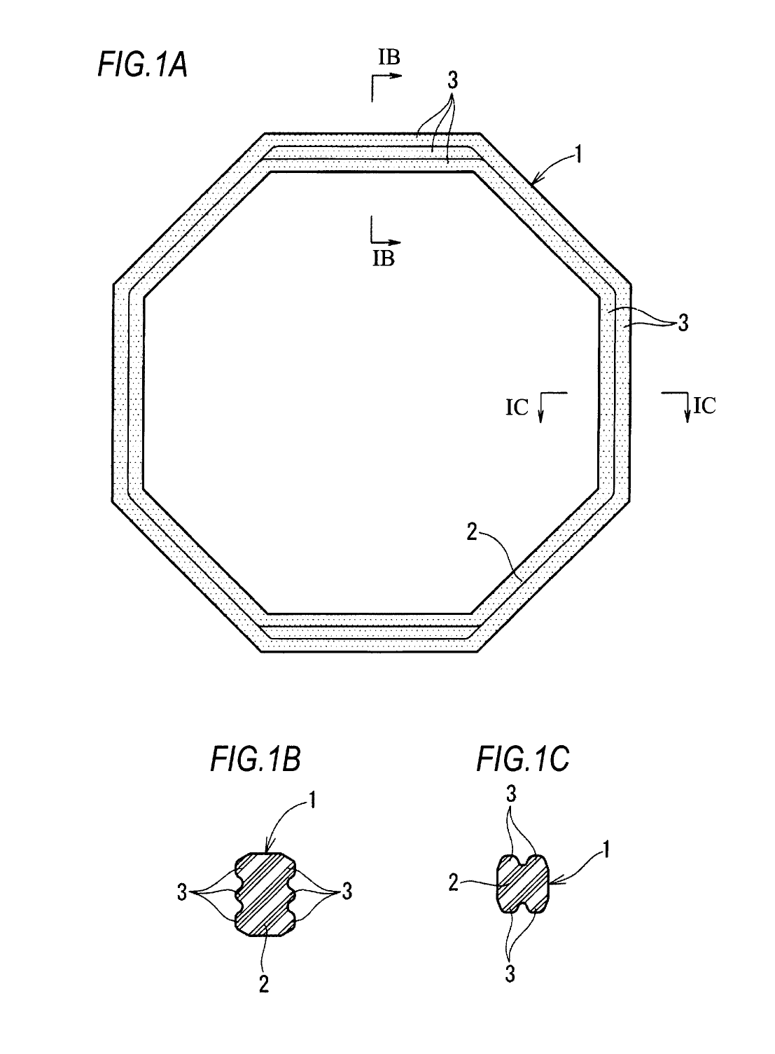

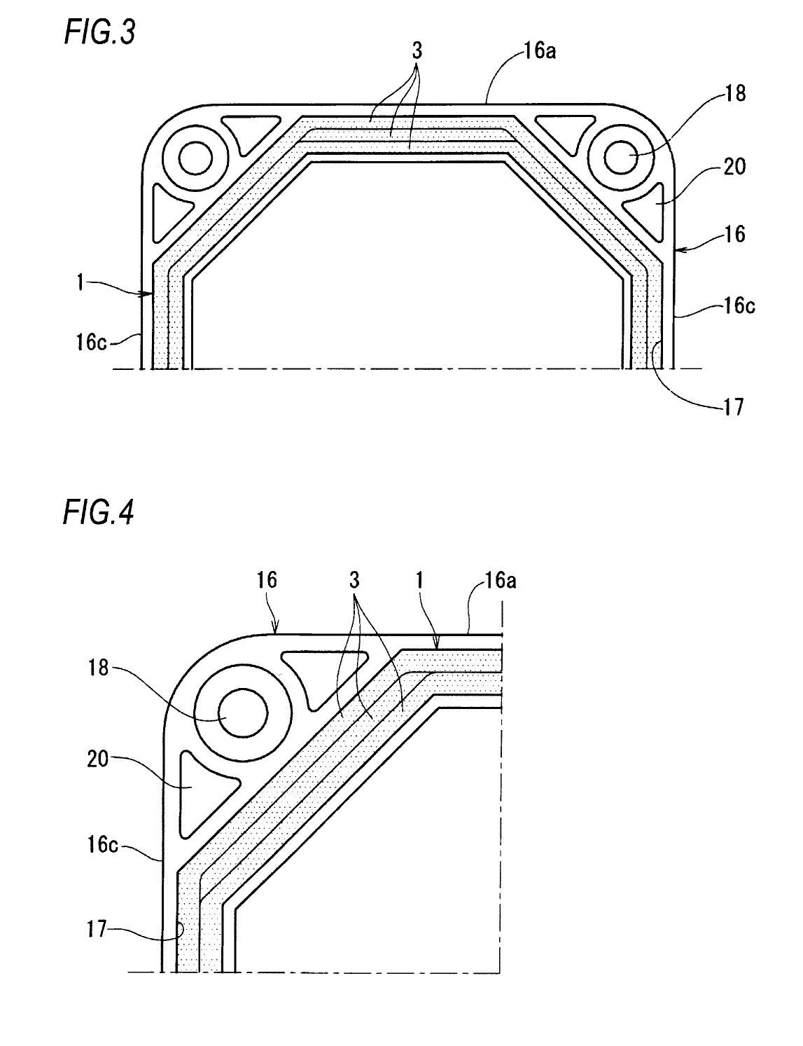

Hereinafter, illustrative embodiments of an annular seal member of this disclosure and a brake fluid pressure control apparatus using the same will be described with reference to FIGS. 1 to 6.

FIGS. 1A to 1C illustrate an example of an annular seal member of this disclosure. An annular seal member 1 of FIGS. 1A to 1C has seal edges 3 that are provided on both end faces of an annular base part 2 and protrude in opposite directions. The three of seal edges 3 are provided only at parts corresponding to one set of two parallel sides of respective parts of the annular base part 2 (refer to FIG. 1B), and the two of seal edges 3 is provided at the other parts (refer to FIG. 1C). The seal edges 3 of the three edges part are arranged in parallel with each other in a direction orthogonal to an orientation direction of the base part 2 (a direction from an outer diameter to an inner diameter), and the seal edges 3 of the two edges part are also arranged in parallel with each other.

Both the outermost seal edge 3 and the innermost seal edge 3 of the base part are endless edges. Among the seal edges 3 of the three edges part, the central seal edge between the outermost seal edge and the innermost seal edge has both ends that are separated from the outermost seal edge 3. However, both ends of the central seal edge may continue to the outermost seal edge 3.

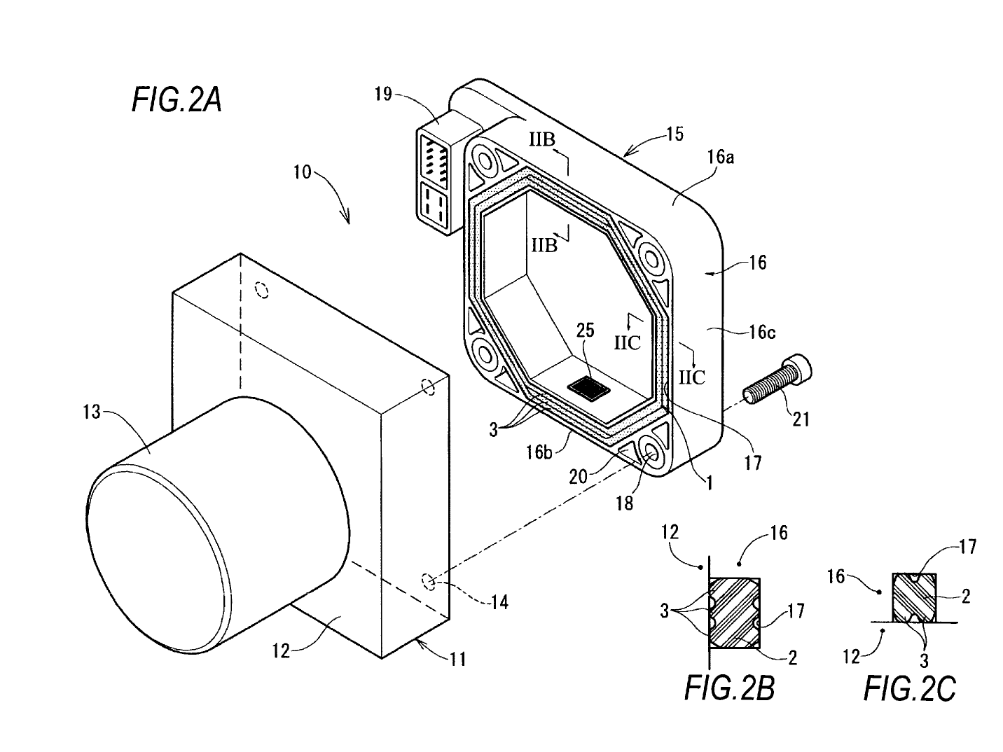

An example of a brake fluid pressure control apparatus for a vehicle using the annular seal member 1 of FIG. 1 is shown in FIG. 2A. The brake fluid pressure control apparatus 10 is configured by a fluid pressure unit 11 and an electronic control unit 15.

The fluid pressure unit 11 has a valve block 12 made of aluminum alloy. A pump (not shown) is installed into the valve block 12, and a motor 13 driving the pump is attached to one side of the valve block 12. Also, a fluid pressure control valve (not shown) that switches a connection state of a fluid pressure circuit provided in the valve block 12 and adjusts a degree of opening of a valve part is installed to an opposite side of the valve block 12 to the side on which the motor is provided. A reference numeral 14 indicates a screw hole, into which a fastening bolt 21 is screwed.

The electronic control unit 15 is fastened to the fluid pressure unit 11 configured as described above. The electronic control unit 15 accommodates a mounting substrate (not shown), which mounts thereon constitutional parts of an electronic control device, in a casing (which is generally made of resin) 16. The electronic control unit 15 is fitted on an opposite side to a side on which the motor of the valve block 12 is provided, and the casing 16 surrounds the fluid pressure control valve installed on the opposite side to the side on which the motor is provided.

At this time, mating faces of the valve block 12 and the casing 16 are fluid-tightly sealed by the annular seal member 1. The annular seal member 1 is inserted into a seal recess 17 that is formed on the mating surface of the casing 16.

When fastening the casing 16 to the valve block 12 by using the fastening bolts 21, the seal edges 3 on both end faces of the base part 2 of the annular seal member 1 are closely contacted and compressed to faces of seal targets (a bottom face of the seal recess 17 and an end face of the valve block 12 facing the bottom face of the seal recess 17). Thereby, the interior and exterior of the casing 16 (an area existing at the inner periphery side of the base part 2 and an area existing at the outer periphery side the base part 2) are fluid-tightly partitioned.

A reference numeral 18 indicates a bolt hole that is provided to the casing 16. The fastening bolt 21 is screwed into the bolt hole 18. A reference numeral 20 indicates a relief part (recess portion or hole) that is provided to the casing 16 as a countermeasure against torsion.

The brake fluid pressure control apparatus 10 is mounted on a vehicle so that the mating faces of the valve block 12 and the casing 16 are inclined with respect to the vertical or horizontal face. At this state, the corrosion factors such as water and salt, which are adhered on the upper face, which is a side of the upper face 16a of the casing, of the apparatus, are apt to remain or deposit. Also, the apparatus is supported by the mount in many cases. In this case, the corrosion factors may also remain and deposit on the lower face, which is a side of the lower face 16b of the casing, contacting the mount.

Therefore, according to the brake fluid pressure apparatus 10 of FIG. 2, in the areas of the annular seal member 1 corresponding to the upper and lower faces of the apparatus, the number of the seal edges 3 provided on both end faces of the base part 2 is three. Thereby, the backup function of the seal is improved in the corresponding areas.

Also, the casing 16 is integrally provided at a side part thereof with a connector part 19 for electrical connection. In this structure, when a horizontal width of the casing is increased, a distance from a target part of the electrical connection to the connector part is changed, so that it is required to replace the mounting substrate with a mounting substrate having a size conforming to the distance change. Therefore, in the area of the base part 2 along the side face of the apparatus, which is a side of a side face 16c of the casing, the number of the seal edges 3, which are provided on both end side faces of the annular seal member 1, are two. There is a product being currently sold having the seal edges of two, so that a size of the casing is not increased in the corresponding area. Since the corrosion factors are apt to run down in the described area, the reliability of the seal is sufficiently secured even when the number of the seal edges 3 is two.

In the meantime, as shown in FIG. 4, when a corner part of the casing 16 is inclined with respect to the horizontal face or the corner part is provided with the bolt hole 18 or relief part 20 to suppress torsion of the casing, the corrosion factors are also apt to remain and deposit on the corner part. Accordingly, in the brake fluid pressure apparatus having such described parts, it is preferable to make the number of the seal edges in an area adjacent to the bolt hole 18 or relief part 20, which area includes the closest area to the bolt hole or relief part, or in an area along a corner inclined with respect to the horizontal face larger than the number of the seal edges in other areas.

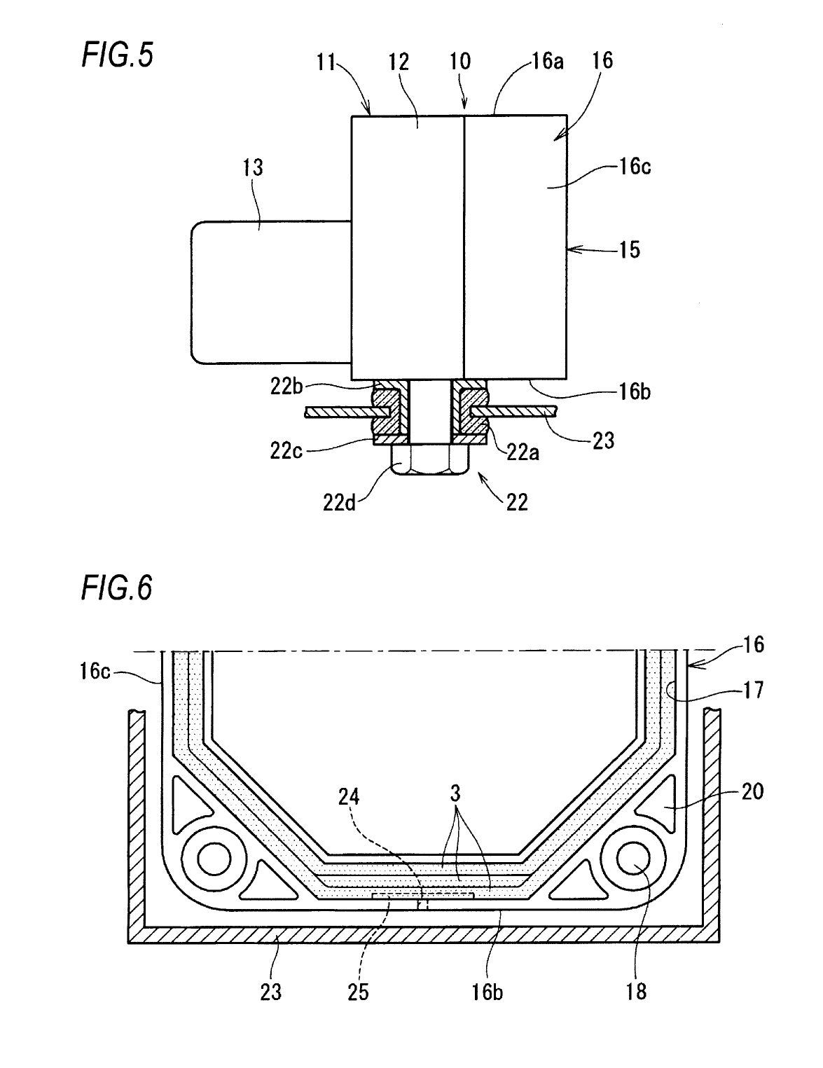

FIG. 5 illustrates a state where the lower face of the brake fluid pressure control apparatus 10 is fixed to a vehicle with being supported by a mount 22 and a bracket 23. The mount 22 has an annular rubber member 22a for buffering, a collar 22b and a spacer 22c sandwiching the rubber member and a bolt 22d fixing the rubber member, the collar and the spacer toward a lower face of the valve block 12. The bracket 23 is fitted in an annular slit formed on an outer periphery of the rubber member 22a and supports the brake fluid pressure apparatus 10. In this case, the adhered corrosion factors are also apt to remain and deposit on the lower face of the apparatus. Therefore, it is preferable to make the number of the seal edges 3 in the area of the base part of the annular seal member 1 along the lower face of the apparatus larger than the number of the seal edges in the other areas.

In addition, as shown in FIG. 6, when the bracket 23 for attaching to the apparatus is provided to the lower part of the apparatus, the corrosion factors remaining and depositing on the bracket 23 may corrode the valve block 12 at the lower face side of the apparatus. Therefore, it is preferable to make the number of the seal edges 3, which are provided at the base part of the annular seal member 1 in the area along the lower face of the apparatus, larger than the number of the seal edges in the other areas.

Meanwhile, in this illustrative embodiment, the lower face 16b of the casing 16 facing the bracket 23 is formed with a breathing hole 24 enabling the air in the casing 16 to pass therethrough. Also, an opening of the breathing hole 24 is provided with a water blocking sheet 25 that blocks the water from passing therethrough. Also, the bracket 23 is arranged to be adjacent to the lower face 16b of the casing 16 and to face the breathing hole 24 to not cause a problem with respect to the support of the apparatus so as to suppress the breathing hole 24 from being wetted due to the water.

As described above, according to the brake fluid pressure control apparatus 10 for a vehicle of this disclosure, the number of the seal edges of the annular seal member 1 is increased in the part at which the corrosion factors are apt to remain and deposit, and the number of the seal edges in the other areas is made to be smaller than the maximum number, thereby suppressing the increase in the seal width. Accordingly, it is possible to improve the reliability of the seal between the mating faces of the valve block and the casing while suppressing the increase in the size of the apparatus.

What is claimed is:

1. An annular seal member comprising:
an annular base part; and
a seal edge, which is provided on both end faces of the annular base part to protrude in opposite directions,
wherein the seal edge is configured to closely contact with a opposing face of a seal target such that an inner periphery side of the base part and an outer periphery side of the base part are fluid-tightly partitioned,
wherein a plurality of the seal edges is provided in parallel with each other in at least one area of the base part, and
wherein the number of the seal edges in the at least one area of the base part is larger than the number of the seal edges in the other area of the base part.

2. The annular seal member according to claim 1,
wherein the number of the seal edges provided in parallel with each other in the at least one area of the base part is three, and
wherein the number of the seal edges provided in parallel with each other in the other area of the base part is two.

3. A brake fluid pressure control apparatus comprising:
a valve block, into which a fluid pressure control valve is installed;
a casing, which accommodates an electronic control device; and
the annular seal member according to claim 1,
wherein the casing is fitted and fastened to the valve block so as to surround the fluid pressure control valve,
wherein the casing and the valve block are fluid-tightly sealed by the annular seal member,
wherein the brake fluid pressure control apparatus is mountable on the vehicle so that mating faces of the valve block and the casing are inclined with respect to a vertical face or a horizontal face,
wherein an area of the base part, which is arranged along an upper face of the control apparatus, is provide with the plurality of the seal edges, and
wherein the number of the seal edges in the area arranged along the upper face is larger than the number of the seal edges in the other area of the base part.

4. A brake fluid pressure control apparatus comprising:
a valve block, into which a fluid pressure control valve is installed;
a casing, which accommodates an electronic control device; and
the annular seal member according to claim 1,
wherein the casing is fitted and fastened to the valve block so as to surround the fluid pressure control valve,
wherein the casing and the valve block are fluid-tightly sealed by the annular seal member,
wherein the brake fluid pressure control apparatus is mountable on the vehicle so that mating faces of the valve block and the casing are inclined with respect to a vertical face or a horizontal face,
wherein at least one of the casing and the valve block is formed with a bolt hole, into which a fastening bolt for fastening the casing and the valve block is screwed,
wherein an area of the base part, which is adjacent to the bolt hole, is provide with the plurality of the seal edges, and
wherein the number of the seal edges in the area adjacent to the bolt hole is larger than the number of the seal edges in the other area of the base part.

5. A brake fluid pressure control apparatus comprising:
a valve block, into which a fluid pressure control valve is installed;
a casing, which accommodates an electronic control device; and
the annular seal member according to claim 1,
wherein the casing is fitted and fastened to the valve block so as to surround the fluid pressure control valve,
wherein the casing and the valve block are fluid-tightly sealed by the annular seal member,
wherein the brake fluid pressure control apparatus is mountable on the vehicle so that mating faces of the valve block and the casing are inclined with respect to a vertical face or a horizontal face,
wherein a lower face of the control apparatus is supported by a mount,
wherein an area of the base part, which is arranged along the lower face of the control apparatus, is provide with the plurality of the seal edges, and
wherein the number of the seal edges in the area arranged along the lower face is larger than the number of the seal edges in the other area of the base part.

6. A brake fluid pressure control apparatus comprising:
a valve block, into which a fluid pressure control valve is installed;
a casing, which accommodates an electronic control device; and
the annular seal member according to claim 1,
wherein the casing is fitted and fastened to the valve block so as to surround the fluid pressure control valve,
wherein the casing and the valve block are fluid-tightly sealed by the annular seal member,
wherein the brake fluid pressure control apparatus is mountable on the vehicle so that mating faces of the valve block and the casing are inclined with respect to a vertical face or a horizontal face,
wherein an attachment bracket is provided at a lower part of the control apparatus,
wherein an area of the base part, which is arranged along the lower part of the control apparatus, is provide with the plurality of the seal edges, and
wherein the number of the seal edges in the area arranged along the lower part is larger than the number of the seal edges in the other area of the base part.

7. The brake fluid pressure control apparatus according to claim 3,
wherein the annular seal member includes an area, in which the seal edge is vertically arranged, and
wherein the number of the vertically arranged seal edges is two.
